(19) United States
(12) Patent Application Publication
(10) Pub. No.: US 2026/0268840 A1
(43) Pub. Date: Sep. 10, 2026

(54) DISPLAY APPARATUS AND METHOD OF CONTROLLING THE SAME

(71) Applicant: LX SEMICON CO., LTD., Daejeon (KR)

(72) Inventors: Ji Hoon CHOI, Daejeon (KR); Yoon Jong YOO, Daejeon (KR); Ho Hyub JEON, Daejeon (KR)

(73) Assignee: LX SEMICON CO., LTD., Daejeon (KR)

(21) Appl. No.: 19/559,185

(22) Filed: Mar. 6, 2026

(30) Foreign Application Priority Data
Mar. 7, 2025 (KR) 10-2025-0029888

(51) Int. Cl. G09G 3/3208

(52) U.S. Cl. CPC G09G 3/3208; G09G 2320/0209; G09G 2320/0285; G09G 2320/041; G09G 2320/0626; G09G 2340/0435; G09G 2360/16

(57) ABSTRACT

A method of controlling a display apparatus according to one embodiment of the present invention includes receiving image data from an external device, detecting temperature information through a temperature sensor in the display apparatus, detecting frame rate information from a driver in the display apparatus, calculating a first gain based on the detected temperature information to be applied to a pixel value of the received image data, and calculating a second gain based on the detected frame rate information to be applied to the pixel value of the received image data.

### CROSS-REFERENCE TO RELATED APPLICATIONS

This application claims the priority and the benefit of the Korean Patent Application No. 10-2025-0029888 filed on Mar. 7, 2025, which is hereby incorporated by reference in its entirety as if fully set forth herein.

### BACKGROUND

### Field of the Invention

Embodiments of the present invention directly or indirectly relate to a display apparatus. As a more specific example, embodiments of the present invention may be applied to an image compensation technology for solving image quality degradation problem due to involuntary movement of a display apparatus.

### Discussion of the Related Art

Display panels refer to screens or apparatuses used for visually displaying information in electronic devices. Display panels developed for various technologies and applications are used in smartphones, TVs, computer monitors, vehicle displays, electronic signs, signage, and the like.

Examples of display panels include a liquid crystal display (LCD), an organic light-emitting diode (OLED), an active-matrix OLED (AMOLED), a micro-OLED (MLED), an OLED on silicon (OLEDoS), and the like.

However, there is a problem of degrading expression of a color intended to be expressed by input image data according to various operating conditions in a panel of a display apparatus and characteristics of the input image data.

### SUMMARY

One embodiment of the present invention is to solve the above-described problems of conventional technology so as to effectively correct a change in color according to an environment and driving conditions such as a crosstalk phenomenon, a temperature, a display brightness value (DBV), and a frame rate which may occur in a display apparatus.

Through this, the present invention is to solve an image quality degradation problem of the display apparatus and provide the best visual experience to a user.

For reference, a crosstalk phenomenon occurs when a specific color is greater than another color in one pixel or when a difference in value between a reference pixel and a surrounding pixel is large, which causes a voltage loss and image degradation.

A method of controlling a display apparatus according to one aspect of the present invention includes receiving image data from an external device, detecting temperature information through a temperature sensor in the display apparatus, detecting frame rate information from a driver in the display apparatus, calculating a first gain based on the detected temperature information to be applied to a pixel value of the received image data, and calculating a second gain based on the detected frame rate information to be applied to the pixel value of the received image data.

The method of controlling a display apparatus according to one aspect of the present invention may further include storing one or more first gains mapped for each of a plurality of temperature ranges in a memory and storing one or more second gains mapped for each of a plurality of frame rate ranges in the memory.

The method of controlling a display apparatus according to one aspect of the present invention may further include determining a brightness level using display brightness value (DBV) information of the image data.

The method of controlling a display apparatus according to one aspect of the present invention may further include, when a result of the determining corresponds to a first level, decreasing a gain value intended to be applied to the pixel value of the received image data as the DBV information increases in a red pixel and a green pixel, and increasing a gain value intended to be applied to the pixel value of the received image data as the DBV information increases in a blue pixel.

The method of controlling a display apparatus according to one aspect of the present invention may further include, when a result of the determining corresponds to a second level, increasing a gain value intended to be applied to the pixel value of the received image data as the DBV information increases in the red pixel and the green pixel, and decreasing a gain value intended to be applied to the pixel value of the received image data as the DBV information increases in the blue pixel.

The method of controlling a display apparatus according to one aspect of the present invention may further include, when a result of the determining corresponds to a third level (for example, the third level is a level including both the first level and the second level), applying another gain value to the pixel value of the received image data using a look-up table (LUT) stored in the memory.

A display apparatus according to another aspect of the present invention includes a receiver module which receives image data from an external device, a temperature sensor which detects temperature information in the display apparatus, a driver which detects frame rate information of the image data, and a controller which calculates a first gain based on the detected temperature information to be applied to a pixel value of the received image data and calculates a second gain based on the detected frame rate information to be applied to the pixel value of the received image data.

### BRIEF DESCRIPTION OF THE DRAWINGS

The accompanying drawings, which are included to provide a further understanding of the disclosure and are incorporated in and constitute a unit of this application, illustrate embodiments of the disclosure and together with the description serve to explain the principle of the disclosure. In the drawings:

FIG. 1 is a view for schematically describing a three-dimensional loop-up table (TDL) technology according to conventional technology;

FIG. 2 is a schematic block diagram illustrating a display apparatus according to one embodiment of the present invention;

FIG. 3 is a detailed block diagram illustrating the display apparatus according to one embodiment of the present invention;

FIG. 4 is a graph for describing a specific operation of a temperature compensation value calculator illustrated in FIG. 3;

FIG. 5 is a graph for describing a specific operation of a frame rate compensation value calculator illustrated in FIG. 3;

FIG. 6 is a graph for describing a specific operation of a first calculator illustrated in FIG. 3 when digital brightness value (DBV) information of image data corresponds to a first level;

FIG. 7 is a graph for describing a specific operation of the first calculator illustrated in FIG. 3 when DBV information of image data corresponds to a second level;

FIG. 8 is a view for describing a specific operation of the first calculator illustrated in FIG. 3 when DBV information of image data corresponds to a third level;

FIG. 9 is a graph for describing a specific operation of a second calculator illustrated in FIG. 3;

FIG. 10 is a view comparing an original image input to a display apparatus according to conventional technology with a display result in an actual display panel;

FIG. 11 is a view comparing an original image input to the display apparatus according to one embodiment of the present invention with a display result in an actual display panel; and

FIG. 12 is a flowchart illustrating a method of controlling a display apparatus according to one embodiment of the present invention.

### DETAILED DESCRIPTION OF THE DISCLOSURE

Like reference numerals refer to substantially the same elements throughout the specification. In the following description, detailed description of components which are not related to core components of the present invention and components and functions which are known in the art of the present invention may be omitted. Meanings of terms described in this specification should be understood as follows.

Advantages and features of the present invention and methods of achieving the same should be clearly understood with reference to the accompanying drawings and the following detailed embodiments. However, the present invention is not limited to the embodiments to be disclosed and may be implemented in various different forms. The embodiments are only provided in order to fully describe the disclosure of the present invention and fully explain the scope of the present invention to those skilled in the art. The scope of the present invention is defined by the appended claims.

Since shapes, sizes, ratios, angles, numbers, and the like illustrated in drawings for describing embodiments of the present invention are exemplary, the present invention is not limited to those illustrated in the drawings. Like reference numerals refer to like elements throughout the specification. In addition, in the description of the present invention, specific detailed descriptions of the related art are omitted when they are deemed to unnecessarily obscure the gist of the invention.

When the terms “comprise,” “include,” “have,” “be formed of,” and the like are used in the present specification, other elements may be added thereto unless “only” is used. A case in which a component is expressed in a singular form includes a case in which the component is provided as a plurality of components unless otherwise explicitly stated.

When an element is interpreted, it is interpreted as including an error range even when there is no separate explicit description.

In the case of location-related description, for example, in a case in which a location relationship between two parts is described with “on,” “above,” “under,” or “beside” one or more parts may be located therebetween unless the term “just” or “directly” is used.

In the case of time-related description, for example, a case in which temporal parts are described with “after,” “before,” or the like may include a case in which the temporal parts are not sequential unless the term “immediately” or “directly” is used.

Although terms such as “first,” “second,” and the like may be used for describing various elements, the elements are not limited by the terms. The terms are only used to distinguish one element from another element. Accordingly, a first element to be mentioned below may also be a second element in a technical spirit of the present invention.

The term “at least one” should be understood to include all possible combinations from one or more related items. For example, “at least one of a first item, a second item, and a third item” may mean not only the first item, the second item, or the third item, but also all possible combinations of two or more items among the first item, second item, and the third item.

Features of various embodiments of the present invention may be partially or entirely coupled or combined and driven in cooperation in various technical ways, and the embodiments may also be implemented independently of each other or implemented together in conjunction with each other.

Hereinafter, embodiments of the present specification will be described in detail with reference to the accompanying drawings.

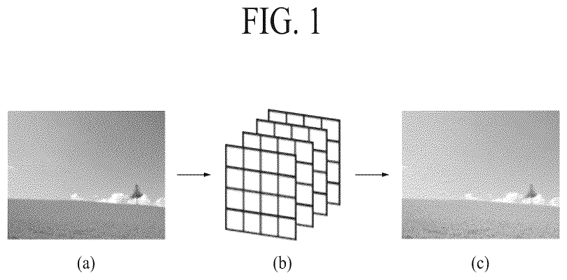

FIG. 1 is a view for schematically describing a three-dimensional loop-up table (TDL) technology according to conventional technology.

FIG. 1A is a view showing an input image, FIG. 1B is a view showing a three-dimensional (3D) look-up table (LUT), and FIG. 1C is a view showing an output image.

Color expression and color consistency may be improved by adjusting and correcting a color by mapping input data of an arbitrary 3D color space to a 3D color space having specific output data using the predefined 3D LUT (see FIG. 1B). In addition, there is also an advantage of controlling a color in a specific region according to an objective of a user.

However, the TDL technology used for color space conversion has a problem of being limitedly used for a specific grayscale in order to respond to a color deviation problem due to a leakage current generated due to crosstalk.

In addition, since the TDL technology according to conventional technology is not a technology developed to respond to the color deviation problem, there is a problem of a difficulty in responding to various operation conditions of a display apparatus and input data.

However, since the present invention is developed to solve various color deviation problems which may occur in display panels, and may respond to a performance change according to various operation environments, the present invention may solve a color deviation problem in a color gamut intended to be expressed by a display panel even when used together with conventional TDL technology.

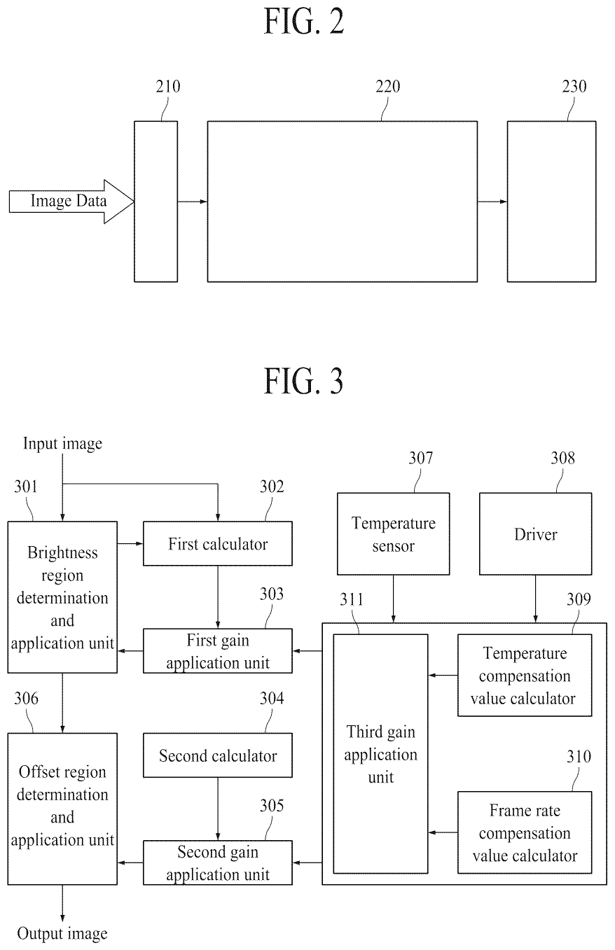

FIG. 2 is a schematic block diagram illustrating a display apparatus according to one embodiment of the present invention.

The display apparatus according to one embodiment of the present invention includes, for example, a receiver module 210, a driver 220, a display panel 230, and the like. The receiver module 210 corresponds to, for example, a system on chip (SoC), an encoder, etc. The driver 220 corresponds to, for example, a display driver integrated circuit (DDIC), etc. Meanwhile, although not illustrated in FIG. 2, the display apparatus according to one embodiment of the present invention may additionally include a temperature sensor, a controller, etc.

The receiver module 210 receives image data from an external device.

The temperature sensor detects temperature information in the display apparatus. In addition, the temperature information may be received through two or more temperature sensors, and a performance may be maximized by receiving the precise temperature information according to a location of each display panel.

The driver 220 detects frame rate information of the image data.

The controller calculates a first gain based on the detected temperature information to be applied to a pixel value of the received image data. In addition, the controller calculates a second gain based on the detected frame rate information to be applied to the pixel value of the received image data.

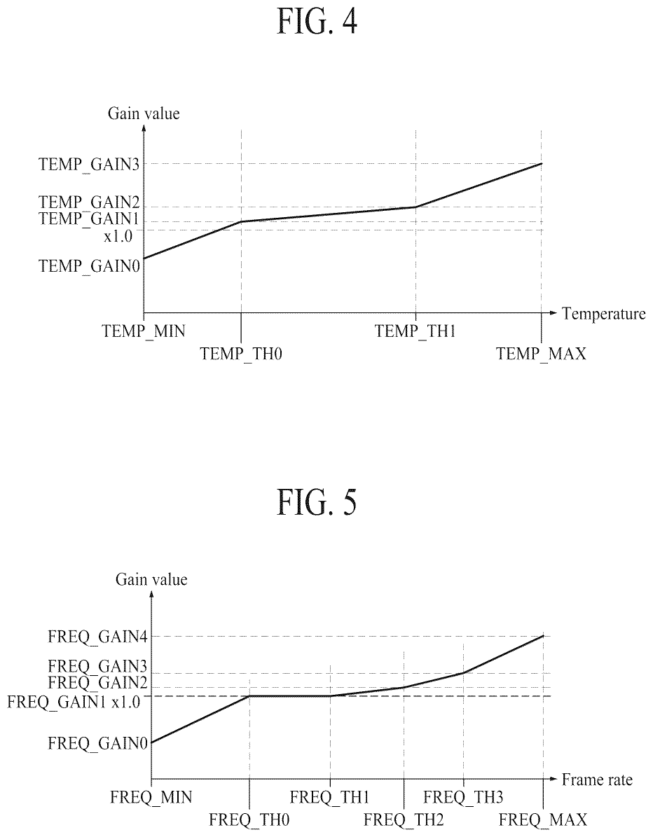

Although not illustrated in FIG. 2, a memory stores one or more first gains mapped for each of a plurality of temperature ranges. A more specific example related thereto will be described in more detail below with reference to FIG. 4.

In addition, the memory stores one or more second gains mapped for each of a plurality of frame rate ranges. A more specific example related thereto will be described in more detail below with reference to FIG. 5.

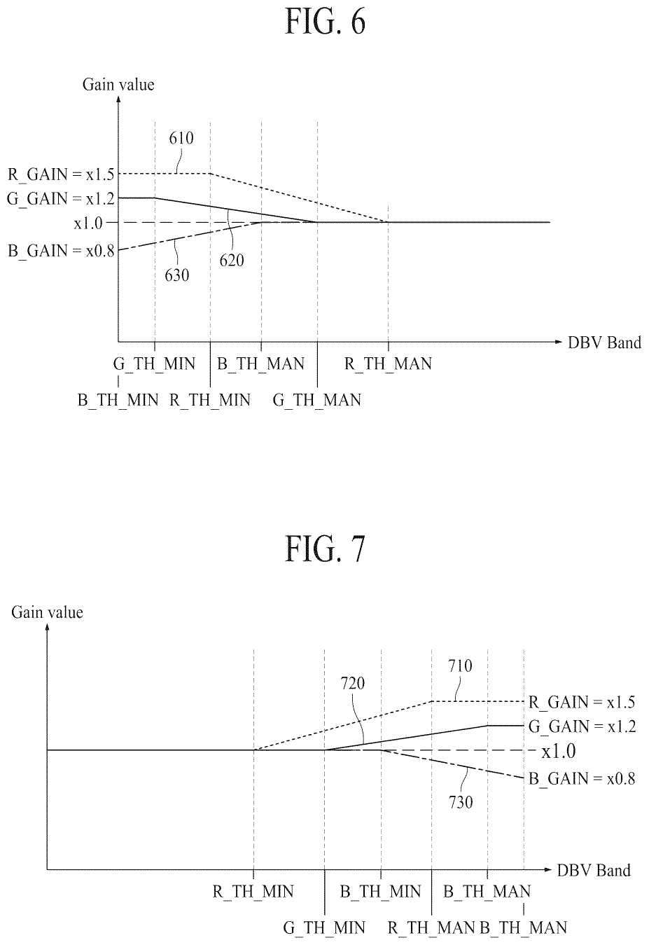

Meanwhile, the controller determines a brightness level using a display brightness value (DBV) of the image data. More specific examples related thereto will be described in more detail below with reference to FIGS. 6 to 8.

FIG. 3 is a detailed block diagram illustrating the display apparatus according to one embodiment of the present invention.

In the display apparatus, degradation of an input image may occur as characteristics of the display panel are changed according to a temperature change. In order to correct this, a temperature compensation value calculator 309 calculates a compensation value according to a temperature value.

The compensation value is calculated using a piecewise linear function (PWL) consisting of, for example, 4 points, and the points for the PWL and the compensation value consist of configuration (cfg) values input by the user.

In the display apparatus, degradation of an input image may occur as the characteristics of the display panel are changed according to a frame rate change. In order to correct this, a frame rate compensation value calculator 310 calculates a compensation value according to a frame rate value.

The compensation value is calculated using a PWL consisting of, for example, 6 points, and the points for the PWL and the compensation value consist of cfg values input by the user.

Frame rate information used in the present invention is determined by the driver of the display apparatus and may be set, changed, and used by the user as needed.

The frame rate information may also be set to be different in two or more regions according to characteristics of an image displayed in the display panel.

Characteristics according to a low brightness, a high brightness, and a medium brightness are different according to the display panel. Accordingly, a brightness region determination and application unit 301 is designed to determine a low brightness, a high brightness, and a medium brightness using an input DBV value, select a proper compensation value, and output a result by multiplying an input image by the compensation value.

A first calculator 302 calculates a compensation value according to an input brightness region.

In addition, the first calculator 302 may include, for example, a low brightness compensation value calculator, a high brightness compensation value calculator, a medium brightness compensation value calculator, etc. More specific examples related thereto will be described in more detail below with reference to FIGS. 6 to 8.

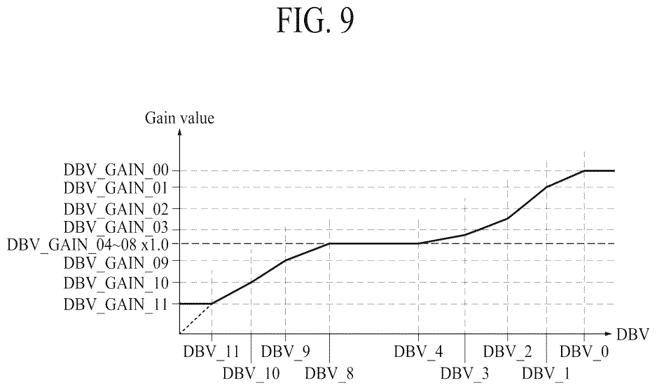

A second calculator 304 calculates a DBV gain. A more specific example will be described in more detail below with reference to FIG. 9.

Two compensation values are multiplied and combined by a third gain application unit 311.

An offset region determination and application unit 306 is designed to add or subtract an offset to or from a surrounding sub-pixel value when a DBV value is a DBV threshold (DBV_TH) or less and a sub-pixel value of a pixel satisfies a specific threshold (TH) condition value.

For example, a red sub-pixel or blue sub-pixel is turned on due to a leakage current generated when a pixel value of an arbitrary green sub-pixel is greater than that of a specific threshold value condition and the red sub-pixel or blue sub-pixel adjacent thereto has a pixel value of zero (specific threshold value condition), and thus, there is a problem that a color expressed on the display panel is changed.

Accordingly, there is a technical effect of minimizing an effect of the leakage current flowing in the corresponding pixel by applying the pixel value offset to the red sub-pixel or blue sub-pixel when the specific threshold value condition is satisfied.

For example, when a pixel value of a green G is a preset threshold value GR_TH_U or more, and a pixel value of a red R is a preset threshold value GR_TH_L or less, a preset offset GR_OFFSET is applied to a red pixel. When a pixel value of a green G is the preset threshold value GR_TH_U or more, and a pixel value of a red R is a preset threshold value RG_TH_L or less, an offset RG_OFFSET is applied to a pixel of the green G. However, both the above-described two conditions are satisfied, the preset offset GR_OFFSET and the offset GB OFFSET are summed and applied thereto.

For example, when a pixel value of a red R is a preset threshold value RG_TH_U or more, and a pixel value of a green G is the preset threshold value RG_TH_L or less, the preset offset RG_OFFSET is applied to a green pixel. When a pixel value of a red R is a preset threshold value RB_TH_U or more, and a pixel value of a blue B is a preset threshold value RB_TH_L or less, a preset offset RB_OFFSET is applied to a blue pixel. However, when both the above-described two conditions are satisfied, the preset offset RG_OFFSET and the offset RB_OFFSET are summed and applied thereto.

For example, when a pixel value of a blue B is a preset threshold value BG_TH_U or more, and a pixel value of a green G is a preset threshold value BG_TH_L or less, a preset offset BG_OFFSET is applied to a green pixel. When a pixel value of a blue B is the preset threshold value RB_TH_U and a pixel value of a red R is a preset threshold value BR TH_L or less, a preset offset BR_OFFSET is applied to a red pixel. However, when both the above-described two conditions are satisfied, the preset offset BG_OFFSET and the offset BR_OFFSET are summed and applied thereto.

It is designed that, when a specific sub-pixel value causing a leakage current in the panel is greater than a preset threshold value or more, and another sub-pixel value by which the leakage current flows due to an effect of the corresponding sub-pixel is smaller than still another preset threshold value, a leakage current phenomenon is minimized by applying an offset value to a sub-pixel of a low value (e.g., zero) in order to prevent the leakage current.

As a more specific example, a threshold value described as GR XXX and an offset value GR_OFFSET determine a correction offset value applied to a R sub-pixel according to values of two sub-pixels including a G sub-pixel and a R sub-pixel.

When the former G sub-pixel has a pixel value greater than the threshold value GR_TH_U, and the latter R sub-pixel has a pixel value smaller than the threshold value GR_TH_L, the offset value is applied to the R sub-pixel of which the pixel value is small.

As a result, in the above example, the G sub-pixel is a sub-pixel causing a leakage current, and the R sub-pixel is a sub-pixel which is turned on (or more brightly turned on) due to the leakage current from the G sub-pixel.

In addition, a final offset OFFSET is calculated by multiplying a compensation value input from a second gain application unit 305, and a final output is calculated by adding or subtracting the final offset OFFSET to or from an input image.

FIG. 4 is a graph for describing a specific operation of the temperature compensation value calculator illustrated in FIG. 3.

In the display apparatus, degradation of an input image may occur as characteristics of the panel are changed according to a temperature change. In order to correct this, a compensation value according to a temperature value is calculated.

A compensation value illustrated in FIG. 4 may be calculated using a PWL consisting of 4 points, and the points for the PWL and the compensation value may consist of cfg values input by the user.

In addition, data illustrated in FIG. 4 may be stored in, for example, the memory of the display apparatus.

When a temperature of the display apparatus corresponds to a first temperature TEMP_MIN, a first gain TEMP_GAIN0 is multiplied by a gain value calculated by the first calculator or the like or applied to an offset value calculated by the second calculator or the like.

Meanwhile, when a temperature of the display apparatus corresponds to a second temperature TEMP_TH0, a second gain TEMP_GAIN1 is multiplied by the gain value calculated by the first calculator or the like or applied to the offset value calculated by the second calculator or the like.

In addition, when a temperature of the display apparatus corresponds to a third temperature TEMP_TH1, a third gain TEMP_GAIN2 is multiplied by the gain value calculated by the first calculator or the like or applied to the offset value calculated by the second calculator or the like.

In addition, when a temperature of the display apparatus corresponds to a fourth temperature TEMP_TH2, a fourth gain TEMP_GAIN3 is multiplied by the gain value calculated by the first calculator or the like or applied to the offset value calculated by the second calculator or the like.

Finally, compensation is performed by a method of multiplying a pixel value by the gain value, which is multiplied by the gain value according to the temperature, or adding the offset value, which is multiplied by the gain value according to the temperature, to a pixel value.

FIG. 5 is a graph for describing a specific operation of the frame rate compensation value calculator illustrated in FIG. 3.

In the display apparatus, degradation of an input image may occur as the characteristics of the panel are changed according to a frame rate change. In order to correct this, a compensation value according to a frame rate value is calculated.

A compensation value illustrated in FIG. 5 is calculated using a PWL consisting of 6 points, and the points for the PWL and the compensation value consist of cfg values input by the user.

Data illustrated in FIG. 5 may be stored in, for example, the memory of the display apparatus.

As an example, when a frame rate of the display apparatus is between a first frame rate FREQ_TH0 and a second frame rate FREQ_TH1, a new gain value is determined using PWL calculation using the first gain FREQ_GAIN1 and a second gain FREQ_GAIN2, and the new gain value is multiplied by a gain value calculated by the first calculator or multiplied by an offset value calculated by the second calculator.

FIG. 6 is a graph for describing a specific operation of the first calculator illustrated in FIG. 3 when digital brightness value (DBV) information of image data corresponds to a first level.

Characteristics according to a low brightness, a high brightness, and a medium brightness are changed according to the display panel. The brightness region determination and application unit 301 determines a low brightness, a high brightness, and a medium brightness using an input DBV value, selects a proper compensation value, multiplies an input image by the compensation value, and outputs a calculation result.

As an example of the controller, the first calculator 302 calculates a compensation value according to an input brightness region.

For example, it is assumed to correspond to the first level (low brightness).

In each of a red pixel 610 and a green pixel 620, as DBV information increases, a gain value to be applied to a pixel value of received image data decreases.

However, in a blue pixel 630, as DBV information increases, a gain value to be applied to a pixel value of received image data increases.

That is, the graph shown in FIG. 6 is summarized in Table 1 below.

TABLE 1

| DBV_TH (DBV Band) | R/G/B_GAIN |
|---|---|
| < R/G/B_TH_MIN | × R/G/B_GAIN |
| R/G/B_TH_MIN~ R/G/B_ TH_MAX | $\frac{Gain - 1}{{TH}_{min} - {TH}_{max}} \times ( DBV - {TH}_{min} ) + Gain$ |
| > R/G/B_TH_MAX | × 1.0 |

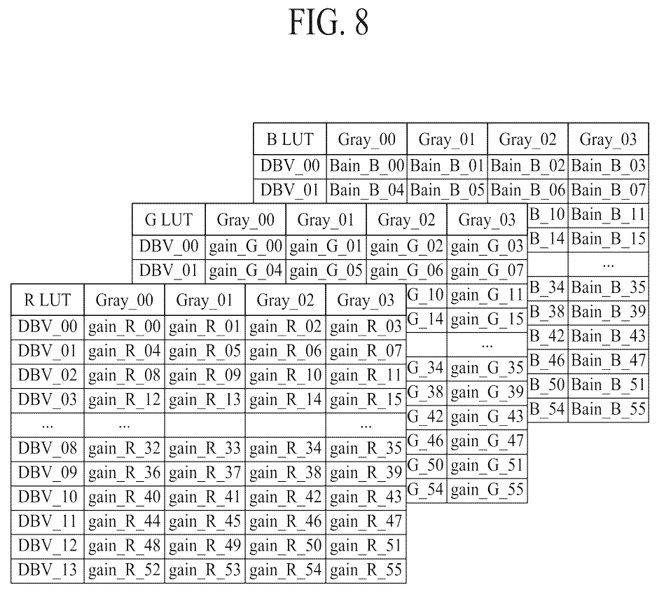

FIG. 7 is a graph for describing a specific operation of the first calculator illustrated in FIG. 3 when DBV information of image data corresponds to a second level.

As an example of the controller, the first calculator 302 calculates a compensation value according to a received brightness region.

For example, it is assumed to correspond to the second level (high brightness)

In each of the red pixel 610 and the green pixel 620, as DBV information increases, a gain value to be applied to a pixel value of received image data increases.

However, in the blue pixel 630, as DBV information increases, a gain value to be applied to a pixel value of received image data decreases.

That is, the graph shown in FIG. 7 is summarized in Table 2 below.

TABLE 2

| DBV_TH (DBV Band) | R/G/B_GAIN |
|---|---|
| < R/G/B_TH_MIN | × 1.0 |
| R/G/B_TH_MIN~ R/G/B_ TH_MAX | $\frac{Gain - 1}{{TH}_{max} - {TH}_{min}} \times ( DBV - {TH}_{min} ) + 1.$ |
| > R/G/B_TH_MAX | × R/G/B_GAIN |

FIG. 8 is a view for describing a specific operation of the first calculator illustrated in FIG. 3 when DBV information of image data corresponds to a third level.

As an example of the controller, the first calculator 302 calculates a compensation value according to a received brightness region.

For example, it is assumed to correspond to the third level (medium brightness). In this case, in the third level, a compensation value may be applied to an entire brightness region including the low brightness and the high brightness.

Another gain value is applied to a pixel value of a received image using an LUT (stored in, for example, the memory) shown in FIG. 8.

That is, brightness (DBV) information and gain information according to the pixel value are prestored in the LUT, and a compensation value to be actually applied is calculated using an interpolation method according to an input brightness and the pixel value.

FIG. 9 is a graph for describing a specific operation of the second calculator illustrated in FIG. 3.

The second calculator calculates a DBV gain. For example, a DBV gain is calculated using a PWL with “the number of DBV bands+1” points.

For example, when a DBV value corresponds to a first level DBV_11, a pixel value of an input image is multiplied by a first gain DBV_GAIN_11.

For example, when a DBV value corresponds to a second level DBV_10, a pixel value of an input image is multiplied by a second gain DBV_GAIN_10.

For example, when a DBV value corresponds to a third level DBV_9, a pixel value of an input image is multiplied by a third gain DBV_GAIN_09.

For example, when a DBV value corresponds to a fourth level DBV_8 and a fifth level DBV_4, a gain value is determined as one. Accordingly, the same pixel value is output without changing an input pixel value.

For example, when a DBV value corresponds to a sixth level DBV_3, a pixel value of an input image is multiplied by a fourth gain DBV_GAIN_03.

For example, when a DBV value corresponds to a seventh level DBV_2, a pixel value of an input image is multiplied by a fifth gain DBV_GAIN_02.

For example, when a DBV value corresponds to an eighth level DBV_1, a pixel value of an input image is multiplied by a sixth gain DBV_GAIN_01.

For example, when a DBV value corresponds to a ninth level DBV_0, a pixel value of an input image is multiplied by a seventh gain DBV_GAIN_00.

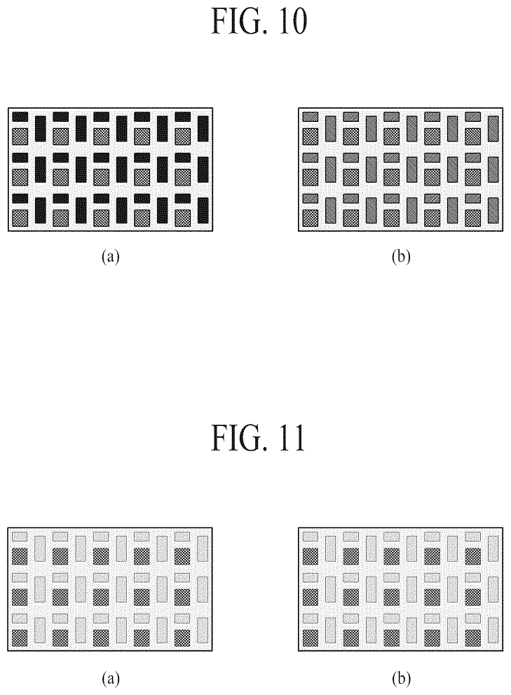

FIG. 10 is a view comparing an original image input to a display apparatus according to conventional technology with a display result in an actual display panel.

FIG. 10A is a view illustrating the original image input to the display apparatus according to conventional technology.

Meanwhile, FIG. 10B is a view illustrating an actual display result in a panel of the display apparatus according to conventional technology.

When FIGS. 10A and 10B are compared, it can be seen that color expression of the original image is degraded,

FIG. 11 is a view comparing an original image input to the display apparatus according to one embodiment of the present invention with a display result in an actual display panel.

FIG. 11A is a view illustrating a case in which an offset is applied to the original image input to the display apparatus according to one embodiment of the present invention.

Meanwhile, FIG. 11B is a view illustrating an actual display result in the panel of the display apparatus according to one embodiment of the present invention.

When FIGS. 11A and 11B are compared, it can be seen that degradation of color expression of the original image is minimized.

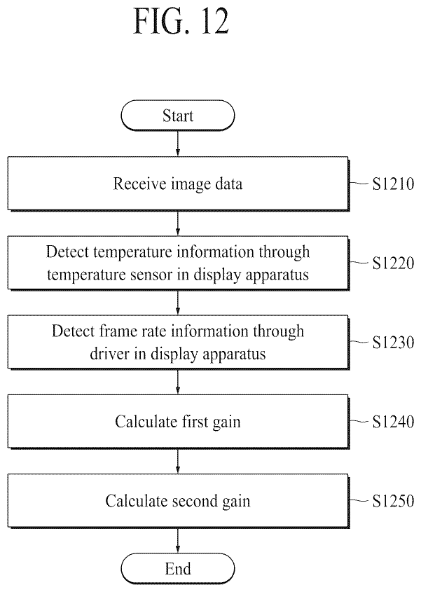

In addition, FIG. 12 is a flowchart illustrating a method of controlling a display apparatus according to one embodiment of the present invention. However, FIG. 12 may be supplementarily interpreted with reference to the previous drawings.

As illustrated in FIG. 12, the display apparatus according to one embodiment of the present invention receives image data from the external device (S1210).

In addition, the display apparatus detects temperature information through the temperature sensor (S1220) and detects frame rate information through the driver (S1230).

In addition, the display apparatus calculates a first gain based on the detected temperature information to be applied to a pixel value of the received image data (S1240).

In addition, the display apparatus calculates a second gain based on the detected frame rate information to be applied to the pixel value of the received image data (S1250).

Meanwhile, although not illustrated in FIG. 12, the display apparatus stores one or more first gains mapped for each of a plurality of temperature ranges in the memory and stores one or more second gains mapped for each of a plurality of frame rate ranges in the memory.

In addition, the display apparatus determines a brightness level using DBV information of the image data. Since an example related thereto is described above with reference to FIGS. 6 to 8, the example may be implemented by those skilled in the art even when the repeated description is omitted.

According to one embodiment of the present invention, there are technical effects of solving various color deviation problems which can occur in a display panel and responding to a performance change according to various operating environments.

In particular, when the present invention is applied together with a three-dimensional loop-up table (TDL) technology, the present invention can solve a color deviation problem in a color gamut intended to be expressed in a display panel.

In addition, there are technologic effects of minimizing a voltage loss and preventing image degradation using an offset in order to prevent a crosstalk phenomenon which is the above-described problem of conventional technology.

In particular, since an organic light emitting diode (OLED) display includes an organic material, a color can be changed according to a temperature change, a display brightness value (DBV), a frame rate, etc. In order to solve such a problem, the present invention has an advantage of accurately expressing a desired color by adaptively determining a gain according to a driving condition and an environment.

In addition, technical effects which may be inferred by those skilled in the art through the present specification and the accompanying drawings in addition to the effects of the invention explicitly described in this specification fall within the scope of the other rights of the present invention.

It will be understood by those skilled in the art that the present invention may be implemented in other concrete forms without changing the technological scope and essential features.

In addition, methods described in the present specification may be at least partially implemented using one or more computer programs or components. The components may be provided as a series of computer instructions through a computer-readable medium or machine-readable medium including a volatile or non-volatile memory. The instructions may be provided as software or firmware and entirely or partially implemented in hardware components such as application specific integrated circuits (ASICs), field programmable gate arrays (FPGAs), digital signal processors (DSPs), or other similar components. The instructions may be executed by one or more processors or other hardware components, and the processes or the other hardware components may perform all or some of methods and procedures disclosed in the present specification or allow them to be performed when executing the series of the computer instructions.

Therefore, the above-described embodiments should be understood as only illustrative in all aspects and not for purposes of limitation. The scope of the present invention is defined not by the detailed description but by the appended claims and encompasses all modifications or alterations derived from meanings, the scope, and equivalents of the appended claims.

What is claimed is:

1. A method of controlling a display apparatus, comprising:
receiving image data from an external device;
detecting temperature information through a temperature sensor in the display apparatus;
detecting frame rate information from a driver in the display apparatus;
calculating a first gain based on the detected temperature information to be applied to a pixel value of the received image data; and
calculating a second gain based on the detected frame rate information to be applied to the pixel value of the received image data.

2. The method of claim 1, further comprising storing one or more first gains mapped for each of a plurality of temperature ranges in a memory, and
storing one or more second gains mapped for each of a plurality of frame rate ranges in the memory.

3. The method of claim 1, further comprising determining a brightness level using display brightness value (DBV) information of the image data.

4. The method of claim 3, further comprising, when a result of the determining corresponds to a first level:
decreasing a gain value intended to be applied to the pixel value of the received image data as the DBV information increases in a red pixel and a green pixel; and
increasing a gain value intended to be applied to the pixel value of the received image data as the DBV information increases in a blue pixel.

5. The method of claim 4, further comprising, when a result of the determining corresponds to a second level:
increasing a gain value intended to be applied to the pixel value of the received image data as the DBV information increases in the red pixel and the green pixel; and
decreasing a gain value intended to be applied to the pixel value of the received image data as the DBV information increases in the blue pixel.

6. The method of claim 5, further comprising, when a result of the determining corresponds to a third level which includes both the first level and the second level, applying another gain value to the pixel value of the received image data using a look-up table (LUT) stored in the memory.

7. A display apparatus comprising;
a receiver module which receives image data from an external device;
a temperature sensor which detects temperature information in the display apparatus;
a driver which detects frame rate information of the image data; and
a controller which calculates a first gain based on the detected temperature information to be applied to a pixel value of the received image data and calculates a second gain based on the detected frame rate information to be applied to the pixel value of the received image data.

8. The display apparatus of claim 7, further comprising a memory which stores one or more first gains mapped for each of a plurality of temperature ranges and stores one or more second gains mapped for each of a plurality of frame rate ranges.

9. The display apparatus of claim 7, wherein the controller determines a brightness level using display brightness value (DBV) information of the image data.

10. The display apparatus of claim 9, wherein, a result of the determining corresponds to a first level, the controller decreases a gain value applied to the pixel value of the received image data as the DBV information increases in a red pixel and a green pixel, and increases a gain value intended to be applied to the pixel value of the received image data as the DBV information increases in a blue pixel.

11. The display apparatus of claim 10, wherein, when a result of the determining corresponds to a second level, the controller increases a gain value intended to be applied to the pixel level of the received image data as the DBV information increases in the red pixel and the green pixel, and decreases a gain value applied to the pixel value of the received image data as the DBV information increases in the blue pixel.

12. The display apparatus of claim 11, wherein, when a result of the determining corresponds to a third level which includes both the first level and the second level, the controller applies another gain value to the pixel value of the received image data using a look-up table (LUT) stored in the memory.
